(19) United States
(12) Patent Application Publication
(10) Pub. No.: US 2009/0296129 A1
(43) Pub. Date: Dec. 3, 2009

(54) PRINTING SYSTEM, PRINTING APPARATUS, IMAGE PROCESSING APPARATUS, AND CONTROL METHOD OF PRINTING SYSTEM

(75) Inventor: Fumiaki Hirose, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/474,096

(22) Filed: May 28, 2009

(30) Foreign Application Priority Data
May 30, 2008 (JP) 2008-142942

(51) Int. Cl. G06K 15/02

(52) U.S. Cl. 358/1.14

(57) ABSTRACT

A printing system including a printing apparatus and an image processing apparatus executes a job when it is appropriate, by reading a plurality of documents printed by the printing apparatus using the image processing apparatus and performing authentication by checking a plurality of pieces of acquired information against each other.

### BACKGROUND OF THE INVENTION

1. Field of the Invention

The present invention relates to printing system, printing apparatus, image processing apparatus, and control method for the printing system.

2. Description of the Related Art

In a printing apparatus, a problem may occur with regards to copyright and security when an original document is printed without permission.

In response to such a problem, recently a technique has been discussed which, when a printing apparatus reads an original document to execute a job, restricts the execution of the job depending on the original document to be read.

For example, Japanese Patent Application Laid-Open No. 2007-14023 discusses a method for combining a copy inhibiting image with a document image, so that in printing the combined image, authentication is required to copy the document. Therefore, a user needs a password to be authenticated to lift the restriction on executing the job.

However, a problem occurs in the authentication method using a password if the user forgets the password or lets out the password to another user.

There is an authentication method that uses an identification (ID) card or biometrical authentication instead of the password. However, such method requires adding an apparatus dedicated to authentication to the printing apparatus.

### SUMMARY OF THE INVENTION

The present invention is directed to an improved printing system, printing apparatus, image processing apparatus, and control method for the printing system.

According to an aspect of the present invention, a printing system includes a printing apparatus and an image processing apparatus. The printing apparatus includes a designation unit configured to designate for each job type whether a job can be executed without performing authentication, an input unit configured to input first image data, a generation unit configured to generate second image data based on the first image data, first information, and designation information indicating a content designated by the designation unit, and third image data based on second information which is checked against the first information to perform the authentication, and a printing unit configured to generate a first document by printing on paper using the second image data, and a second document by printing on paper using the third image data. The image processing apparatus includes a reading unit configured to read the first document and input the second image data, and read the second document and input the third image data, a first determination unit configured to determine the job type to be executed using the second image data, an acquisition unit configured to acquire the first information and the designation information from the second image data, and the second information from the third image data, a second determination unit configured to determine whether a job belonging to the job type determined by the first determination unit can be executed without performing the authentication, based on the job type determined by the first determination unit and the designation information acquired by the acquisition unit, an authentication unit configured to perform the authentication, when the second determination unit determines the job belonging to the job type determined by the first determination unit cannot be executed without performing the authentication, by checking the first information acquired by the acquisition unit against the second information acquired by the acquisition unit, and an execution unit configured to execute, when the authentication by the authentication unit is successful, or when the second determination unit determines the job belonging to the job type determined by the first determination unit can be executed without performing the authentication, the job belonging to the job type determined by the first determination unit using the second image data input by the reading unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a system configuration according to a first exemplary embodiment of the present invention.

FIG. 2 is a block diagram illustrating a configuration of a personal computer (PC) according to the first exemplary embodiment of the present invention.

FIG. 3 is a block diagram illustrating a configuration of a printer according to the first exemplary embodiment of the present invention.

FIG. 4 is a block diagram illustrating details of a control unit according to the first exemplary embodiment of the present invention.

FIG. 5 is a schematic diagram illustrating a process for generating a composite document according to the first exemplary embodiment of the present invention.

FIG. 6 is a flowchart illustrating a process for generating a composite document according to the first exemplary embodiment of the present invention.

FIG. 7 is a flowchart illustrating a detailed process for generating authentication information according to the first exemplary embodiment of the present invention.

FIG. 8 illustrates a setting screen displayed on an operation unit in a setting process according to the first exemplary embodiment of the present invention.

FIG. 9 illustrates authentication information generated in the authentication information generation process according to the first exemplary embodiment of the present invention.

FIG. 10 is a schematic diagram illustrating a process for executing a job based on a composite document according to the first exemplary embodiment of the present invention.

FIG. 11 is a flowchart illustrating a process for executing a job based on a composite document according to the first exemplary embodiment of the present invention.

FIG. 12 is a flowchart illustrating details of an authentication process according to the first exemplary embodiment of the present invention.

FIG. 13 illustrates a setting screen displayed on the operation unit in a selection process of an authentication method according to the first exemplary embodiment of the present invention.

FIG. 14 is a schematic diagram illustrating a process for generating a composite document according to a second exemplary embodiment of the present invention.

FIG. 15 illustrates authentication information generated in an authentication information generation process according to the second exemplary embodiment of the present invention.

FIG. 16 is a schematic diagram illustrating a process for executing a job based on a composite document according to the second exemplary embodiment of the present invention.

### DETAILED DESCRIPTION OF THE EMBODIMENTS

Various exemplary embodiments, features, and aspects of the invention will be described in detail below with reference to the drawings.

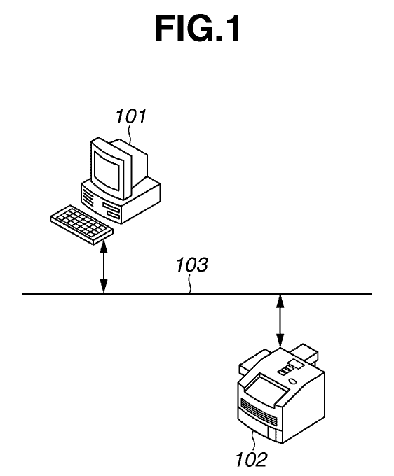

FIG. 1 illustrates a system configuration according to a first exemplary embodiment of the present invention.

A PC 101 is connected to a printer 102 via a network 103 to transmit data such as image data. The PC 101 and the printer 102 can also be locally connected.

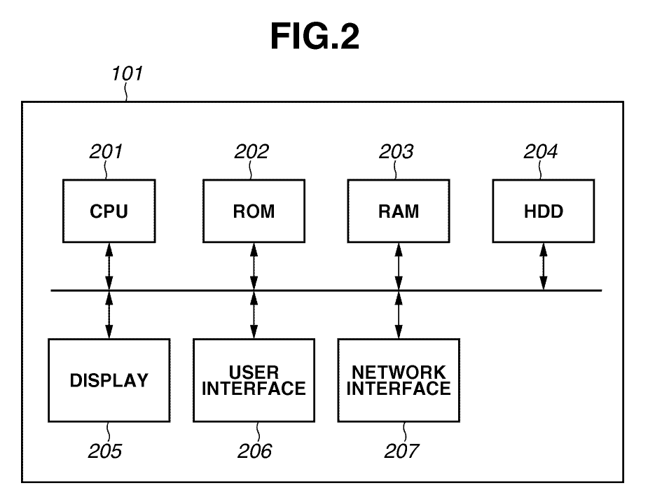

FIG. 2 is a block diagram illustrating a configuration of the PC 101 according to the first exemplary embodiment.

A central processing unit (CPU) 201 controls each of components 202, 203, 204, 205, 206, and 207 in the PC 101 according to a program loaded in a random access memory (RAM) 203. A read-only memory (ROM) 202 (a non-volatile storage medium) stores a boot program and the like to be executed by the CPU 201. A hard disk drive (HDD) 204 (a non-volatile storage medium) stores an operating system (OS) and application programs which are loaded into the RAM 203 (a volatile storage medium) to be executed by the CPU 201. A display 205 displays various information in the PC 101 to a user. A user interface 206 receives various inputs to the PC 101 from the user using a mouse or a keyboard. A network interface 207 inputs and outputs image data to and from an external device such as the printer 102.

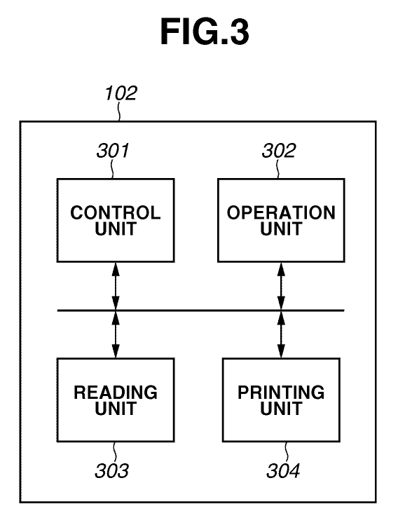

FIG. 3 is a block diagram illustrating a configuration of the printer 102 according to the first exemplary embodiment.

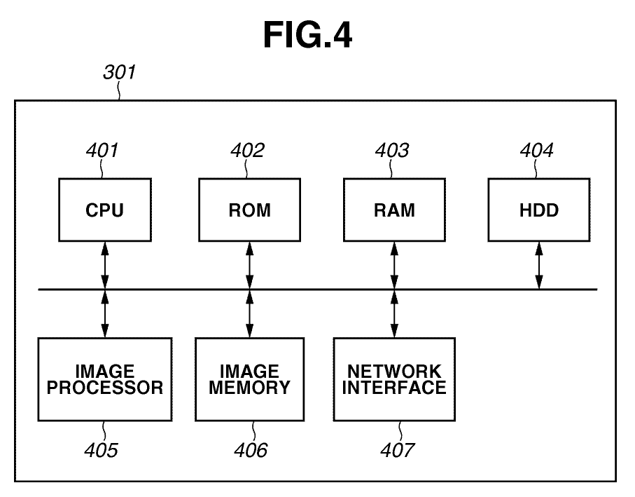

A control unit 301 controls components 302, 303, and 304 in the printer 102. The control unit 301 will be described in detail below with reference to FIG. 4. An operation unit 302 includes a display unit which provides an operation screen of the printer 102 to the user and an input unit which receives various operations on the printer 102 from the user. A reading unit 303 reads image data from a document and inputs the read image data to the control unit 301. A printing unit 304 forms an image on an output sheet according to the image data on which image processing is performed by the control unit 301.

FIG. 4 is a block diagram illustrating details of the control unit 301 according to the first exemplary embodiment according to the first exemplary embodiment.

A CPU 401 controls each of the components 302, 303, and 304 in the printer 102 and components 402, 403, 404, 405, 406, and 407 in the printer control unit 301 based on a program loaded in a RAM 403. A ROM 402 (a non-volatile storage medium) stores a boot program and the like to be executed by the CPU 401. An HDD 404 (a non-volatile storage medium) stores the OS and the application programs which are loaded into the RAM 403 (a volatile storage medium) to be executed by the CPU 401. An image processor 405 executes various image processing on the image data stored in an image memory 406. The image memory 406 (a volatile storage medium) temporarily stores the image data input from the reading unit 303 and a network interface 407. The network interface 407 inputs and outputs image data between external devices such as the PC 101.

Types of jobs performed by the printing system include copy, print, fax, send, and box jobs. In the copy job, the printing unit 304 prints image data read by the reading unit 303. In the print job, the printing unit 304 prints image data received from the PC 101 via the network interface 407. In the fax job, the image data read by the reading unit 303 is transmitted and received using a telephone line. In the send job, the image data read by the reading unit 303 is transmitted and received using a network. In the box job, the image data read by the reading unit 303 is stored in a storage medium such as the HDD 204.

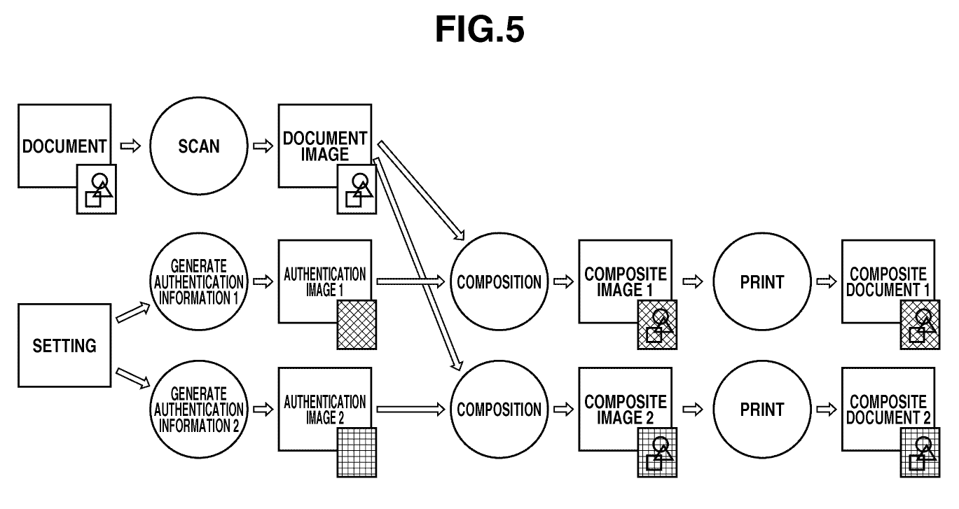

FIG. 5 is a schematic diagram illustrating a process for generating a composite document according to the first exemplary embodiment.

Referring to FIG. 5, the CPU 401 scans a document and inputs image data of a document image. Further, the CPU 401 generates authentication information 1 and authentication information 2 based on document ID acquired from a setting input by the user. The CPU 401 then generates an authentication image 1 and an authentication image 2 according to each of the authentication information 1 and the authentication information 2 respectively.

The CPU 401 combines the image data of the document image with each of the image data of the authentication image 1 and the authentication image 2 to generate image data of a composite image 1 and image data of a composite image 2 respectively. The CPU 401 then prints each of the composite image 1 and the composite image 2 on paper and outputs a composite document 1 and a composite document 2.

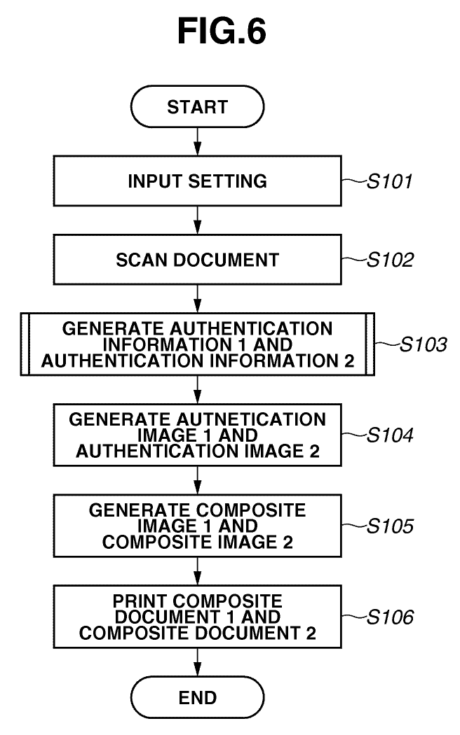

FIG. 6 is a flowchart illustrating the process for generating the composite document according to the first exemplary embodiment. The CPU 401 reads out a program stored in the HDD 404 to the RAM 403 and executes the program to perform control illustrated in the flowchart of FIG. 6.

In step S101, the user inputs settings to the operation unit 302.

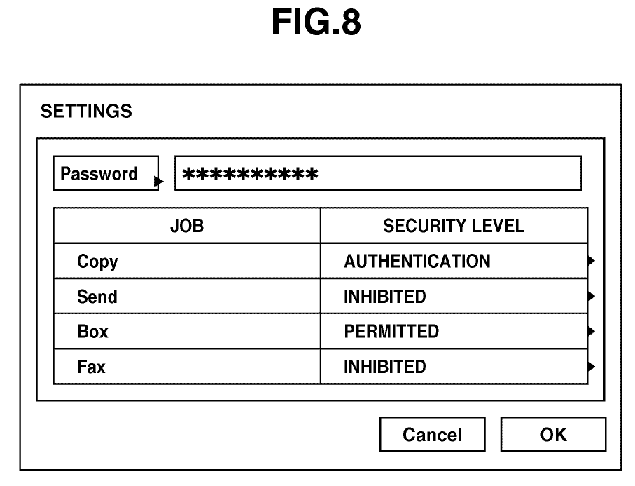

FIG. 8 illustrates an example of a setting screen displayed in the operation unit 302 when the process described in step S101 is performed. The user can set a security level to each job on the setting screen illustrated in FIG. 8. The security level can be set differently for each user. Further, the user can set a password to be used to perform authentication. The example illustrated in FIG. 8 indicates the settings in which the copy job requires authentication, the send and fax jobs are inhibited regardless of the authentication, and the box job is permitted regardless of the authentication.

Returning to FIG. 6, in step S102, the reading unit 303 reads a document as a document image.

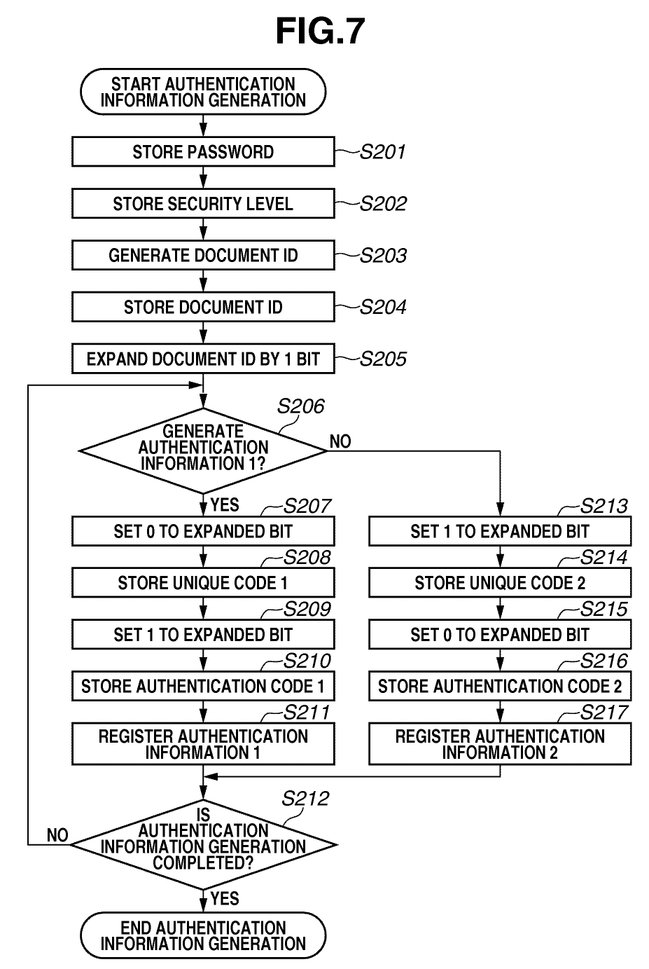

In step S103, the CPU 401 generates authentication information based on settings input by the user in step S101. The process performed in step S103 will be described in detail below with reference to FIG. 7. The CPU 401 generates two types of authentication information (i.e., authentication information 1 and authentication information 2) in step S103.

In step S104, the image processor 405 generates two types of authentication images (i.e., authentication image 1 and authentication image 2) based on the two types of authentication information generated in step S103. The process performed in step S104 will be described in detail below.

In step S105, the image processor 405 generates two types of composite images (i.e., composite image 1 and composite image 2) by combining the document image read in step S102 and each of the two types of authentication images generated in step S104.

In step S106, the printing unit 304 prints each of the two types of composite images generated in step S105 and outputs two types of composite documents (composite document 1 and composite document 2).

Referring to step S104, the CPU 401 executes an authentication image generation program stored in the HDD 404. The authentication image generation program generates code data corresponding to the authentication information by performing a predetermined functional process on the authentication information as input information.

Further, the authentication image generation program generates an authentication image based on a plurality of pieces of the code data so that the code data forms a two-dimensional image corresponding to a size of the document read in step S102. It is desirable that the authentication image is generated as an image which is not easily visible to a human eye. By generating such an authentication image, visibility of the composite document can be prevented from degrading if the authentication image is combined to generate the composite image. The generation of the composite document will be described below.

Further, if the printer 102 is a color printer using four color toners of yellow, magenta, cyan, and black, it is desirable to generate the authentication image to be printed in the yellow toner. Since a portion printed by the yellow toner is generally less visible in the generated document, it can prevent degradation of visibility of the composite document when the authentication image is combined.

FIG. 7 is a flowchart illustrating details of the authentication information generation process performed in step S103 in FIG. 6 according to the first exemplary embodiment.

In step S201, the CPU 401 stores the password set by the user in step S101 in FIG. 6 in the HDD 404.

In step S202, the CPU 401 stores the security level set by the user in step S101 in the HDD 404.

In step S203, the CPU 401 generates document ID. The document ID is unique ID for each document which is assigned to the document data to identify and manage printouts.

In step S204, the CPU 401 stores the document ID generated in step S203 in the HDD 404.

In step S205, the CPU 401 expands a number of digits in the document ID generated in step S203 by one bit. The expanded bit can be located at the beginning or the end of the document ID.

In step S206, the CPU 401 determines whether to generate the authentication information 1. The CPU 401 determines to generate the authentication information 1 if the authentication information 1 is not generated, and determines not to generate the authentication information 1 if the authentication information 1 is already generated. If the CPU 401 determines to generate the authentication information 1 (YES in step S206), the process proceeds to step S207. On the other hand, if the CPU 401 determines not to generate the authentication information 1 (NO in step S206), the process proceeds to step S213.

In step S207, the CPU 401 sets “0” to the bit which is expanded in step S205.

In step S208, the CPU 401 stores the value set in step S207 in the HDD 404 as a unique code 1.

In step S209, the CPU 401 sets “1” to the bit which is expanded in step S205.

In step S210, the CPU 401 stores the value set in step S209 in the HDD 404 as an authentication code 1.

In step S211, the CPU 401 registers the password stored in step S201, the security level stored in step S202, the document ID stored in step S204, the unique code 1 stored in step S208, and the authentication code 1 stored in step S210 as the authentication information 1.

In step S212, the CPU 401 determines whether the generation of the authentication information 1 and the authentication information 2 has been completed. If the CPU 401 determines that the generation of both the authentication information 1 and the authentication information 2 is completed (YES in step S212), the process ends. If he CPU 401 determines that the generation of either or both of the authentication information 1 and the authentication information 2 are not completed (NO in step S212), the process returns to step S206.

Returning to step S206, if the CPU 401 determines not to generate the authentication information 1 (NO in step S206), the process proceeds to step S213, and the CPU 401 sets “1” to the bit which is expanded in step S213.

In step S214, the CPU 401 stores the value set in step S213 in the HDD 404 as a unique code 2.

In step S215, the CPU 401 sets “0” to the bit which is expanded in step S205.

In step S216,the CPU 401 stores the value set in step S215 in the HDD 404 as an authentication code 2.

In step S217, the CPU 401 registers the password stored in step S201, the security level stored in step S202, the document ID stored in step S204, the unique code 2 stored in step S214, and the authentication code 2 stored in step S216 as the authentication information 2.

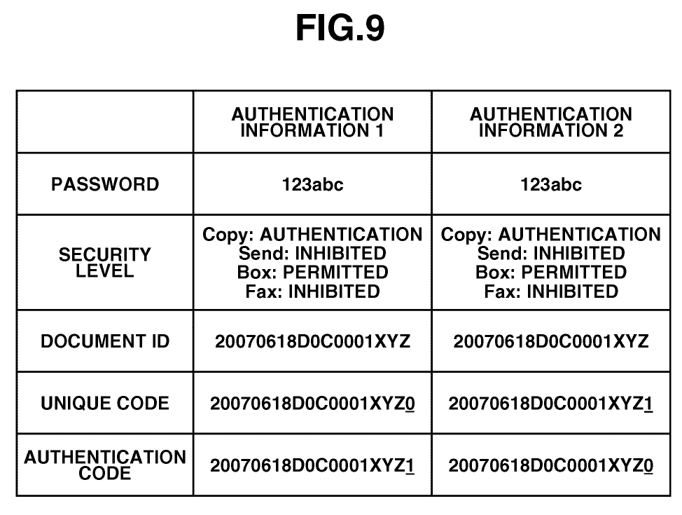

FIG. 9 illustrates an example of the authentication information generated in the authentication information generation process step S103 in FIG. 1 according to the first exemplary embodiment.

Referring to FIG. 9, the authentication information 1 and the authentication information 2 share the same password, security level, and document ID. In contrast, the unique codes and the authentication codes of the authentication information 1 and the authentication information 2 are different. The example illustrated in FIG. 9 indicates that the unique code 1 corresponds to the authentication code 2, and the unique code 2 corresponds to the authentication code 1.

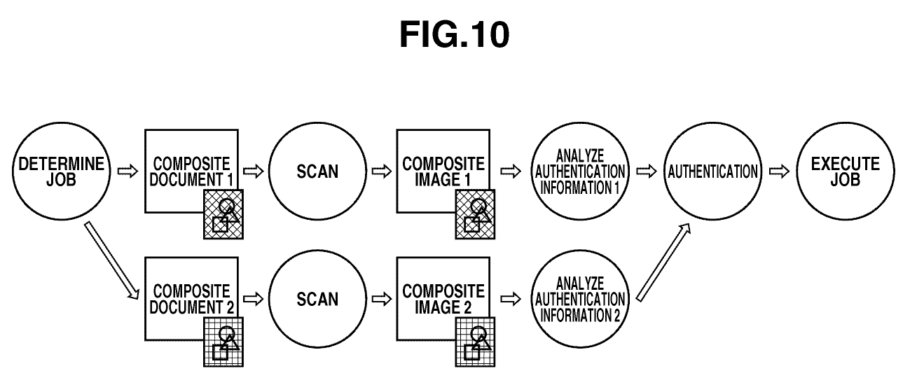

FIG. 10 is a schematic diagram illustrating a process for executing a job based on the composite document according to the first exemplary embodiment.

First, the CPU 401 determines the job to be executed. The user selects the job to be executed from copy, send, box, and fax jobs.

The CPU 401 then scans each of the composite document 1 and the composite document 2 and inputs the image data of the composite image 1 and the image data of the composite image 2.

The CPU 401 analyzes each of the image data of the authentication information 1 in the composite image 1 and the authentication information 2 in the composite image 2. The CPU 401 then executes the authentication process based on the analyzed data. If the authentication succeeds, the CPU 401 executes the determined job based on the composite image 1.

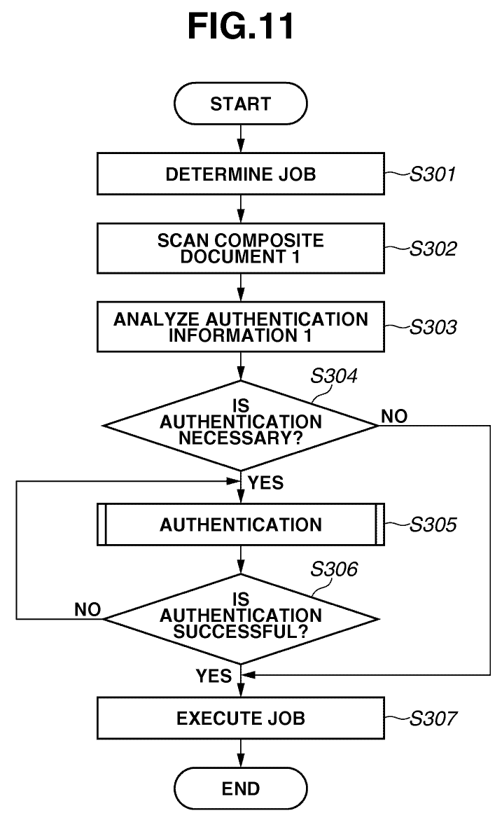

FIG. 11 is a flowchart illustrating the process for executing the job based on the composite document according to the first exemplary embodiment. The CPU 401 reads out a program stored in the HDD 404 to the RAM 403 and executes the program to perform control illustrated in the flowchart of FIG. 11.

In step S301, the CPU 401 determines the type of job to be executed.

In step S302, the CPU 401 reads the composite document 1 printed in step S106 by the reading unit 303 and inputs the composite image 1.

In step S303, the CPU 401 analyzes the authentication information 1 generated in step S103 from the composite image 1 read in step S302. The process performed in step S303 will be described in detail below.

In step S304, the CPU 401 determines whether authentication is necessary for executing the job determined in step S301 using the composite document 1 read in step S302 by confirming the security level 1 included in the authentication information 1 analyzed in step S303. If the CPU 401 determines that authentication is necessary (YES in step S304), the process proceeds to step S305. On the other hand, if the CPU 401 determines that authentication is not necessary (NO in step S304), the process proceeds to step S307.

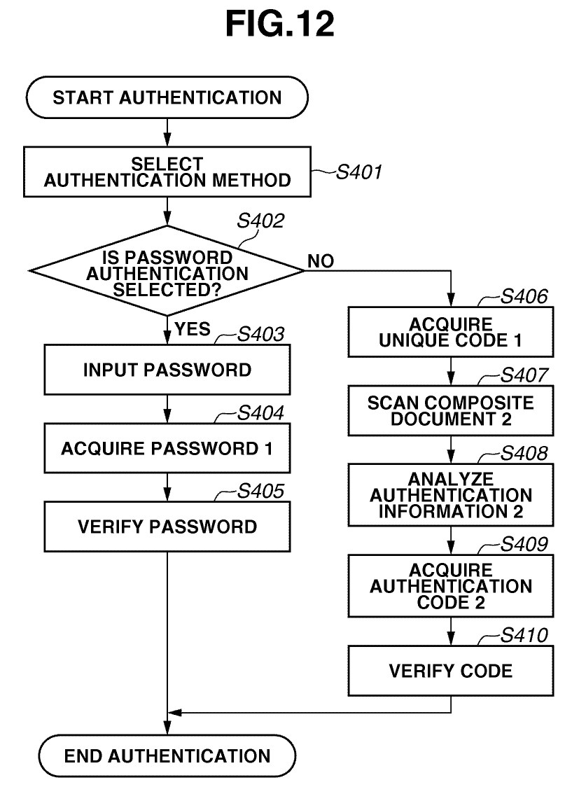

In step S305, the CPU 401 performs authentication. The process performed in step S305 will be described in detail below with reference to FIG. 12.

In step S306, the CPU 401 determines whether the authentication performed in step S305 is successful. If the CPU 401 determines that the authentication is successful (YES in step S306), the process proceeds to step S307. If the CPU 401 determines that the authentication is not successful (NO in step S306), the process returns to step S305.

In step S307, the CPU 401 executes the job determined in step S301 using the composite document 1 read in step S302.

FIG. 12 is a flowchart illustrating the details of the authentication process performed in step S305 in FIG. 11 according to the first exemplary embodiment.

In step S401, the CPU 401 receives an authentication method selected by the user.

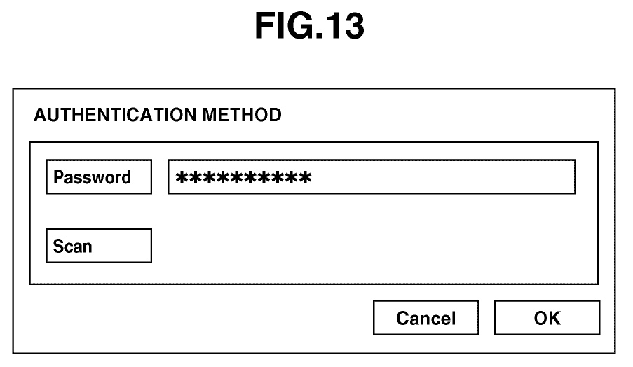

FIG. 13 illustrates an example of a setting screen displayed in the operation unit 302 for the user to select the authentication method in step S401 in FIG. 12 according to the first exemplary embodiment. Referring to FIG. 13, the user can select either a password or a scan authentication method. If the user selects the password authentication, the user can input a password for authentication, and the authentication is performed by using the password stored in step S201 in FIG. 7. If the user selects the scan authentication, authentication is performed by using the authentication code generated in steps S210 and S216 in FIG. 7.

Returning to FIG. 12, in step S402, the CPU 401 determines whether the user selected the password authentication. If the user selected the password authentication (YES in step S402), the process proceeds to step S403. On the other hand, if the user did not select the password authentication (NO in step S402), the process proceeds to step S406.

In step S403, the CPU 401 receives the password input by the user which is necessary for performing the authentication. In the present exemplary embodiment, the user inputs the password on the same screen as the authentication method selection screen illustrated in FIG. 13. However, the password can be input on a different screen from the authentication method selection screen.

In step S404, the CPU 401 acquires a first password included in the authentication information 1 analyzed in step S303 in FIG. 11.

In step S405, the CPU 401 verifies the password input by the user in step S403 by checking against the password confirmed in step S404. If the password input by the user in step S403 matches the password confirmed in step S404, the authentication is successful. On the other hand, if the passwords do not match, the authentication fails.

In step S406, the CPU 401 acquires the unique code 1 included in the authentication information 1 analyzed in step S303 in FIG. 11.

In step S407, the reading unit 303 reads the composite document 2 printed in step S106 in FIG. 6 and inputs the composite image 2.

In step S408, the CPU 401 analyzes the authentication information 2 generated in step S103 in FIG. 6 from the composite image 2 read in step S407. The process performed in step S408 will be described in detail below.

In step S409, the CPU 401 acquires the authentication code 2 included in the authentication information 2 analyzed in step S408.

In step S410, the CPU 401 verifies the unique code 1 confirmed in step S406 by checking against the authentication code 2 confirmed in step S409. If the unique code 1 confirmed in step S406 matches the authentication code 2 confirmed in step S409, the authentication is successful. If the unique code 1 does not match the authentication code 2, the authentication fails.

In step S303 in FIG. 11 and step S408 in FIG. 12, the CPU 401 executes an authentication information analysis program stored in the HDD 404. The authentication information analysis program analyzes the code data embedded in the composite image acquired by reading the composite document and extracts the authentication information from the analyzed code data. For example, if the code data is generated from the authentication information 1 in step S102 in FIG. 6, the CPU 401 analyzes the code data from the composite image and extracts the authentication information 1 from the analyzed code data. Further, if the code data is generated from the authentication information 2 in step S102 in FIG. 6, the CPU 401 analyzes the code data from the composite image and extracts the authentication information 2 from the analyzed code data.

As described above, in the first exemplary embodiment, the same document image is printed in the composite document land the composite document 2. Further, the composite document 1 and the composite document 2 include the authentication information different from each other (i.e., authentication information 1 and authentication information 2), and authentication is performed by checking the authentication information against each other. As a result, one of the composite document 1 and the composite document 2 (can be either one) can be distributed for circulation, and the other can be stored for authentication.

In a second exemplary embodiment of the present invention, hardware configurations are the same as that described using FIGS. 1, 2, 3, and 4 in the first exemplary embodiment, so that further description will be omitted.

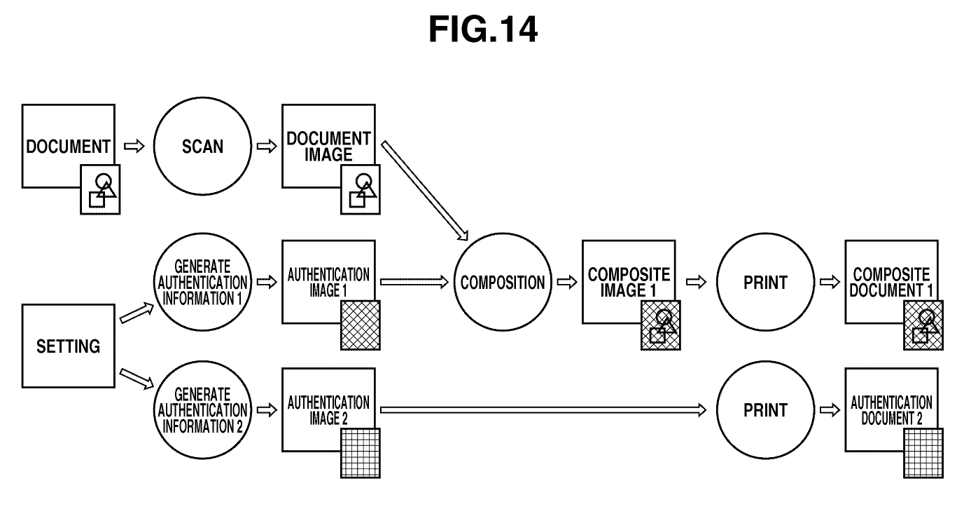

FIG. 14 is a schematic diagram illustrating a process for generating a composite document according to the second exemplary embodiment.

Referring to FIG. 14, the CPU 401 scans the document and inputs the image data of the document image. The CPU 401 also generates the authentication information 1 and the authentication information 2 according to the setting input by the user and generates the image data of each of the authentication image 1 and the authentication image 2 based on the authentication information 1 and the authentication information 2 respectively. The CPU 401 then combines the image data of the document image and the authentication image 1 to generate the composite image 1. The CPU 401 prints each of the composite image 1 and the authentication image 2 on paper and outputs the composite document 1 and the authentication document 2.

Flowcharts for generating the composite document according to the second exemplary embodiment are basically similar to the flowcharts illustrated in FIGS. 6 and 7 in the first exemplary embodiment. The steps which are different will be described below.

In step S105 in FIG. 6, the image processor 405 combines the document image read in step S102 and the authentication image 1 generated in step S104 to generate the composite image 1. In step S106, the printing unit 304 prints the composite image 1 generated in FIG. 105 to output as the composite document 1, and prints the authentication image 2 generated in S104 to output as the authentication document 2.

Referring to FIG. 7, the CPU 401 does not perform steps S209 and S210. In step S211, the CPU 401 registers the password stored in step S201, the security level stored in step S202, the document ID stored in step S204, and the unique code 1 stored in step S208 as the authentication information 1. Further, the CPU 401 does not perform steps S213 and S214. In step S217, the CPU 401 registers the document ID stored in step S204 and the authentication code 2 stored in step S216 as the authentication information 2.

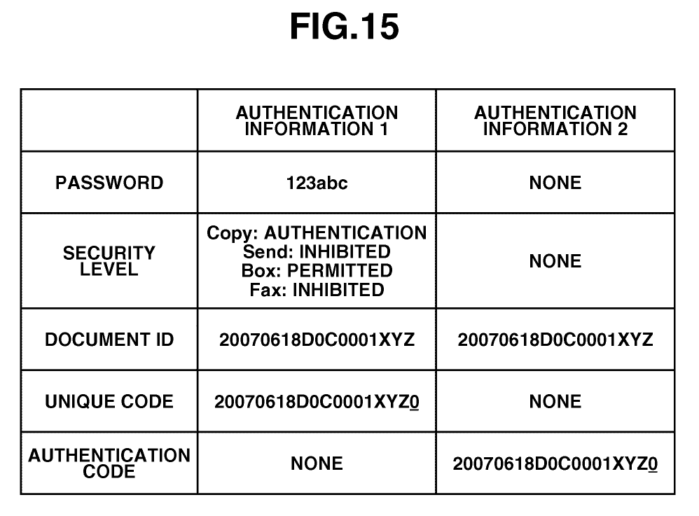

FIG. 15 illustrates an example of the authentication information generated in the authentication information generation performed in step S103 according to the second exemplary embodiment.

Referring to FIG. 15, the password, the security level, and the document ID are only stored in the authentication information 1. Further, the unique code is only stored in the authentication information 1, and the authentication code is only stored in the authentication information 2. In the example illustrated in FIG. 15, the unique code 1 corresponds to the authentication code 2.

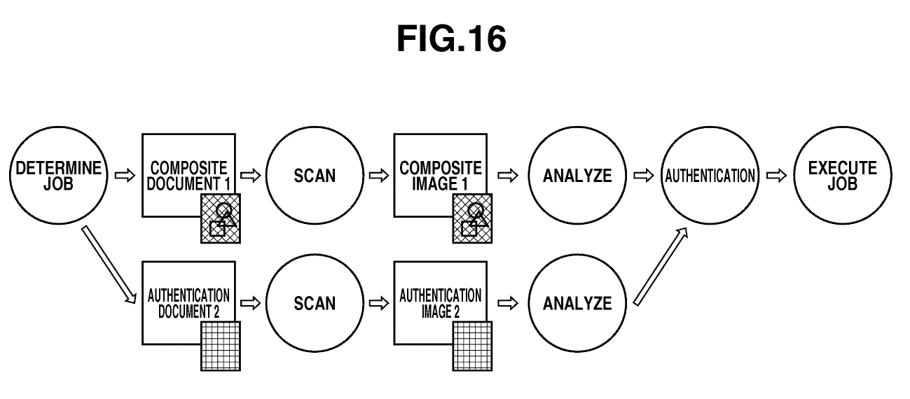

FIG. 16 is a schematic diagram illustrating a process for executing a job based on the composite document according to the second exemplary embodiment.

The CPU 401 determines the job to be executed. The CPU 401 then scans each of the composite document 1 and the authentication document 2 and inputs the image data of the composite image 1 and the authentication image 2. The CPU 401 analyzes each of the image data of the composite image 1 and the authentication image 2 and performs authentication based on the analyzed data. If the authentication is successful, the CPU 401 executes the determined job using the composite image 1.

Flowcharts for executing a job based on the composite document according to the second exemplary embodiment are basically similar to the flowcharts illustrated in FIGS. 11 and 12 in the first exemplary embodiment. The steps which are different will be described below.

Referring to FIG. 12, in step S407, the reading unit 303 reads the authentication document 2 printed in step S106. In step S408, the CPU 401 analyzes the authentication information 2 generated in step S103 from the authentication document 2 read in step S407.

As described above, according to the second exemplary embodiment, the document image is only printed in the composite document 1. Further, the composite document 1 and the authentication document 2 each include the authentication information (i.e., authentication information 1 and authentication information 2) which are different from each other. The authentication is executed by checking the authentication information 1 against the authentication information 2. Therefore, the composite document 1 can be distributed for circulation, and the authentication document 2 is stored for authentication.

According to the second exemplary embodiment, when a job is executed, a plurality of documents printed by the printing apparatus is read by the image processing apparatus. By checking the acquired plurality of pieces of information against each other and performing authentication, the job can be executed when it is appropriate.

Further, according to the second exemplary embodiment, the document image is printed only on the composite document 1. Therefore, the composite document 1 can be distributed, and the authentication document 2 is stored for authentication. Further, one page of the authentication document 2 can be output for one page of the composite image as well as for a plurality of pages or a plurality of jobs of the composite image.

The present invention can also be achieved by providing a storage medium which stores software (program code) for implementing functions of the above-described exemplary embodiments to a system or an apparatus.

In this case, the software (program code) itself realizes the functions of the above-described exemplary embodiments. The software (program code) itself and the storage medium that stores the software (program code) constitute the present invention.

The storage medium can be, for example, a floppy disk, a hard disk, a ROM, an optical disk, a magneto-optical disk, a compact disc ROM (CD-ROM), a digital versatile disc-ROM (DVD-ROM), a DVD-RAM, a magnetic tape, and a memory card.

Further, the present invention includes a case where an operating system (OS) or the like working on a computer can also perform a part or the whole of processes according to instructions of the software (program code) and realize functions of the above-described exemplary embodiments.

Furthermore, the present invention includes a case where software (program code) read from a storage medium can be stored in a memory equipped in a function expansion unit connected to a computer, and a CPU in the function expansion unit can execute all or a part of the processing according to the instructions of the software (program code) to realize the functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-142942 filed May 30, 2008, which is hereby incorporated by reference herein in its entirety.

What is claimed is:

1. A printing system including a printing apparatus and an image processing apparatus, the printing apparatus comprising:
a designation unit configured to designate for each job type whether a job can be executed without performing authentication;
an input unit configured to input first image data, a generation unit configured to generate second image data based on the first image data, first information, and designation information indicating a content designated by the designation unit, and third image data based on second information which is checked against the first information to perform the authentication; and
a printing unit configured to generate a first document by printing on paper using the second image data, and a second document by printing on paper using the third image data, and the image processing apparatus comprising:
a reading unit configured to read the first document and input the second image data, and read the second document and input the third image data;
a first determination unit configured to determine the job type to be executed using the second image data;
an acquisition unit configured to acquire the first information and the designation information from the second image data, and the second information from the third image data;
a second determination unit configured to determine whether a job belonging to the job type determined by the first determination unit can be executed without performing the authentication, based on the job type determined by the first determination unit and the designation information acquired by the acquisition unit;
an authentication unit configured to perform the authentication, when the second determination unit determines the job belonging to the job type determined by the first determination unit cannot be executed without performing the authentication, by checking the first information acquired by the acquisition unit against the second information acquired by the acquisition unit; and
an execution unit configured to execute, when the authentication by the authentication unit is successful, or when the second determination unit determines the job belonging to the job type determined by the first determination unit can be executed without performing the authentication, the job belonging to the job type determined by the first determination unit using the second image data input by the reading unit.

2. The printing system according to claim 1, wherein the generation unit generates the third image data based on the first image data and the second information.

3. The printing system according to claim 1, wherein the printing apparatus further comprises a setting unit configured to set the first information and the second information based on third information which specifies the first image data.

4. The printing system according to claim 3, wherein the third information is document identification (ID) assigned to the first image data for management.

5. The printing system according to claim 4, wherein the setting unit sets the first information and the second information by adding one bit of a digit to the document ID.

6. The printing system according to claim 1, wherein the first information and the second information are the same information.

7. The printing system according to claim 1, wherein the authentication unit determines that the authentication is successful if the first information acquired by the acquisition unit matches the second information acquired by the acquisition unit.

8. The printing system according to claim 1, wherein the image processing apparatus further comprises an output unit configured to perform printing on paper using image data, and
wherein the execution unit controls the output unit to perform printing on paper using the second image data input by the reading unit, if a job determined by the first determination unit is a copy job.

9. A printing apparatus comprising:
a designation unit configured to designate for each job type whether a job can be executed without performing authentication;
an input unit configured to input first image data;
a generation unit configured to generate second image data based on the first image data, first information, and designation information indicating a content designated by the designation unit, and third image data based on second information which is checked against the first information to perform the authentication; and
a printing unit configured to generate a first document by printing on paper using the second image data, and a second document by printing on paper using the third image data.

10. The printing apparatus according to claim 9, wherein the generation unit generates the third image data based on the first image data and the second information.

11. The printing apparatus according to claim 9, further comprising a setting unit configured to set the first information and the second information based on third information which specifies the first image data.

12. The printing apparatus according to claim 11, wherein the third information is document identification (ID) assigned to the first image data for management.

13. The printing apparatus according to claim 12, wherein the setting unit sets the first information and the second information by adding one bit of a digit to the document ID.

14. The printing apparatus according to claim 9, wherein the first information and the second information are the same information.

15. An image processing apparatus comprising:
a reading unit configured to read a first document and input first image data, and read a second document and input second image data;
a first determination unit configured to determine a job type to be executed using the first image data;
an acquisition unit configured to acquire first information and designation information in which it is designated for the each job type whether a job can be executed without performing authentication from the first image data, and second information from the second image data;
a second determination unit configured to determine whether a job belonging to the job type determined by the first determination unit can be executed without performing the authentication, based on the job type determined by the first determination unit and the designation information acquired by the acquisition unit;
an authentication unit configured to perform authentication, when the second determination unit determines the job belonging to the job type determined by the first determination unit cannot be executed without performing the authentication, by checking the first information acquired by the acquisition unit against the second information acquired by the acquisition unit; and
an execution unit configured to execute, when the authentication by the authentication unit is successful, or when the second determination unit determines the job belonging to the job type determined by the first determination unit can be executed without performing the authentication, the job belonging to the job type determined by the first determination unit using the first image data input by the reading unit.

16. The image processing apparatus according to claim 15, wherein the authentication unit determines that the authentication is successful if the first information acquired by the acquisition unit matches the second information acquired by the acquisition unit.

17. The image processing apparatus according to claim 15, further comprising an output unit configured to perform printing on paper using image data, and
wherein the execution unit controls the output unit to perform printing on paper using the second image data input by the reading unit, if a job determined by the first determination unit is a copy job.

18. A method for controlling a printing system including a printing apparatus and an image processing apparatus, the method comprising:
designating for each job type whether a job can be executed without performing authentication;
inputting first image data;
generating second image data based on the first image data, first information, and designation information indicating a designated content, and third image data based on second information which is checked against the first information to perform the authentication;
generating a first document by printing on paper using the second image data, and a second document by printing on paper using the third image data;
reading the first document and inputting the second image data, and reading the second document and inputting the third image data;
determining a job type to be executed using the second image data;
acquiring the first information and the designation information from the second image data, and the second information from the third image data;
determining whether a job belonging to the determined job type can be executed without performing the authentication, based on the determined job type and the acquired designation information;
performing authentication, when it is determined that the job belonging to the determined job type cannot be executed without performing the authentication, by checking the acquired first information against the acquired second information; and
executing, when the authentication is successful, or when it is determined that the job belonging to the determined job type can be executed without performing the authentication, the job belonging to the determined job type using the input second image data.
